(19) United States
(12) Patent Application Publication
(10) Pub. No.: US 2023/0122122 A1
(43) Pub. Date: Apr. 20, 2023

(54) Electronic Gaming Device and System for Replicating a Single Window Game with Configurable Symbols to Multi-Window Game with Persistent Configurable Symbols

(71) Applicant: Aristocrat Technologies Australia Pty Limited, North Ryde (AU)

(72) Inventors: Alessandro Sidoti, St Ives (AU); Dinh Toan Tran, Wetherill Park (AU); Xin Liu, Denistone West (AU); Nicholas O'Sullivan, Beacon Hill (AU); Romit Aggarwal, Kellyville (AU); Emma Mahr, Schofields (AU); Sunny Bansal, Schofields (AU); Chithra Pv, Epping (AU)

(21) Appl. No.: 17/953,232

(22) Filed: Sep. 26, 2022

(30) Foreign Application Priority Data
Sep. 27, 2021 (AU) 2021240127

(51) Int. Cl. G07F 17/32; G07F 17/34

(52) U.S. Cl. CPC G07F 17/3211; G07F 17/34

(57) ABSTRACT

An electronic gaming device comprises a display and a controller. The controller may have a processor, and a memory that stores a symbol set and instructions. A base game instance and a feature game may be initiated. In the base game, reel strips for the base game are mapped for each configurable symbol. An indicator may form part of the respective configurable symbol. Upon the occurrence of threshold number of triggering configurable symbols in the base game, a feature game is triggered that converts a single game window to a plurality of game windows. The triggering configurable symbols of the first game window are replicated at corresponding symbol positions in each other game window displayed. Upon one or more triggering configurable symbols including a mystery indicator, a prize value indicator may be revealed. Until an end condition occurrence, game instances continue. An award outcome may be generated.

### RELATED APPLICATION(S)

The present application claims priority to Australian Patent Application No. AU 2021240127, filed Sep. 27, 2021, and entitled “Gaming Device with Mystery Configurable Symbols” which is hereby incorporated by reference in its entirety.

### BACKGROUND

The present application relates to a gaming device, a method of operating a gaming device and a system with mystery configurable symbols (e.g. cash on reel symbols).

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are therefore highly regulated. Upon initiation of play, the RNG randomly determines a game outcome and symbols are then selected which correspond to that outcome. Notably, some games may include an element of skill on the part of the player and are therefore not entirely random.

Gaming systems or devices may allow players to win awards. The awards may be determined based on predefined volatility criteria or return-to-player. Yet technical problems exist involving how a gaming device may satisfy a designated game return-to-player that either complies with applicable regulations for certain game features or is set to achieve a certain game volatility, where the gaming device involves a single window game instance converted to multiple window game instances based on random outcomes, with persistent game symbols and increasing the numbers of ways to win based on bet sizes. To meet or satisfy a target volatility criterion or designated RTP, the random nature of a game determination may, in a such a game conversion configuration with increasing the number of game instances in display windows, in turn and for example, drive a game device to over process and generate numerous game outcomes in the background for each display window before determining and displaying a game outcome to a player that satisfies the target volatility criterion or designated RTP for the designated jurisdiction.

Repeated determination of whether each of the numerous game outcomes yields the designated volatility each time the game is played may be an inefficient, and time and resource consuming process. Additionally, the confined screen size of many gaming devices creates challenges as to how game changes and related information are effectively communicated to the viewer.

### SUMMARY

There is disclosed a gaming device, a method of operating a gaming device and a system where a configurable symbols (often referred to as “Cash on Reel” symbols) can be selected during a base game. The configurable symbols can be configured with prize indicators such as the name of a prize or a prize amount. The configurable symbols can also be given a mystery prize indicator. If a triggering number of configurable symbols are selected, a feature game is triggered in which the triggering configurable symbols are replicated in a plurality of game windows (e.g. four). If a mystery configurable symbol is included in the trigger, prize indicators are independently allocated to the mystery symbols in each game window so that when the prizes are revealed, the game windows can have different prizes at the positions where the mystery symbols were previously located. All prize amounts are awarded at the end of the feature game.

An example embodiment describes a gaming device comprising a display, a random number generator, a processor, and a memory storing instructions. When the instructions are executed by the processor, they cause the processor to conduct a base game by configuring reel strips for the base game by selecting for each configurable symbol of the reel strips, an indicator to form part of the respective configurable symbol upon the configurable symbol being displayed, wherein each indicator is selected from a plurality of prize value indicators and a mystery prize indicator using the random number generator, selecting, using the random number generator, symbols from the configured reels strips for a plurality of symbol positions of a first game window, and controlling the display to display the selected symbols at the plurality of symbol positions in the first game window. The instructions cause the processor to trigger a feature game upon the selected symbols including a threshold number of configurable symbols, and conduct the feature game by controlling the display to display a plurality of game windows including the first game window, replicating the triggering configurable symbols of the first game window at corresponding symbol positions in each other game window, upon the replicated triggering configurable symbols including one or more configurable symbols with a mystery indicator, revealing prize value indicators determined using the random number generator for each configurable symbol with a mystery indicator and each replicated configurable symbol with a mystery indicator, conducting, until an end condition is met, game instances in which further configurable symbols may be selected at one or more symbol positions not already occupied by a configurable symbol, and making an award of at least the prizes indicated by the prize value indicators in each active game window of the plurality of game windows.

Another example embodiment describes a method of operating a gaming device comprising a display, and a random number generator. The method comprising conducting a base game by configuring reel strips for the base game by selecting for each configurable symbol of the reel strips, an indicator to form part of the respective configurable symbol upon the configurable symbol being displayed, wherein each indicator is selected from a plurality of prize value indicators and a mystery prize indicator using the random number generator, selecting, using the random number generator, symbols from the configured reels strips for a plurality of symbol positions of a first game window, and controlling the display to display the selected symbols at the plurality of symbol positions in the first game window. The method comprises triggering a feature game upon the selected symbols including a threshold number of configurable symbols, and conducting the feature game by controlling the display to display a plurality of game windows including the first game window, replicating the triggering configurable symbols of the first game window at corresponding symbol positions in each other game window, upon the replicated triggering configurable symbols including one or more configurable symbols with a mystery indicator, revealing prize value indicators determined using the random number generator for each configurable symbol with a mystery indicator and each replicated configurable symbol with a mystery indicator, conducting, until an end condition is met, game instances in which further configurable symbols may be selected at one or more symbol positions not already occupied by a configurable symbol, and making an award of at least the prizes indicated by the prize value indicators in each active game window of the plurality of game windows.

Another example embodiment describes a system comprising at least one display, a random number generator, one or more processors, and at least one memory storing instructions. When the instructions are executed by the one or more processors, cause the one or more processors to conduct a base game by configuring reel strips for the base game by selecting for each configurable symbol of the reel strips, an indicator to form part of the respective configurable symbol upon the configurable symbol being displayed, wherein each indicator is selected from a plurality of prize value indicators and a mystery prize indicator using the random number generator, selecting, using the random number generator, symbols from the configured reels strips for a plurality of symbol positions of a first game window, and controlling the display to display the selected symbols at the plurality of symbol positions in the first game window. The instructions cause the processor to trigger a feature game upon the selected symbols including a threshold number of configurable symbols, and conduct the feature game by controlling the display to display a plurality of game windows including the first game window, replicating the triggering configurable symbols of the first game window at corresponding symbol positions in each other game window, upon the replicated triggering configurable symbols including one or more configurable symbols with a mystery indicator, revealing prize value indicators determined using the random number generator for each configurable symbol with a mystery indicator and each replicated configurable symbol with a mystery indicator, conducting, until an end condition is met, game instances in which further configurable symbols may be selected at one or more symbol positions not already occupied by a configurable symbol, and making an award of at least the prizes indicated by the prize value indicators in each active game window of the plurality of game windows.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIG. 3 illustrates an example reel strip layout.

FIG. 4 is a flow chart of a symbol selection method.

FIG. 5 is a flow chart of a method of operating a gaming device.

FIG. 6 is another flow chart of a method of operating a gaming device.

FIGS. 7 to 10 are example screen displays.

### DETAILED DESCRIPTION

In an implementation, a gaming device employs a reel-specific lookup tables technique that dynamically configures a number of reels with a plurality of configurable symbols based on one or more of weighted tables to satisfy one or more of a designated or target RTP, target game outcome, target game payout, target game volatility, target win liability, target maximum win liability, and jurisdictional requirements, while providing multiple features based on one or more of a plurality of mystery symbols from the plurality of configurable symbols on one or more of the number of reels. The configurable symbols can be configured with prize indicators such as the name of a prize or a prize amount. The configurable symbols can also be given a mystery prize indicator. During a game instance, when a threshold number of configurable symbols are displayed, a feature game having multiple windows that duplicate the game instance are displayed, while satisfying, meeting, or maintaining the designated or target RTP, target game outcome, target game payout, target game volatility, target win liability, target maximum win liability, and jurisdictional requirements.

For example, if the threshold number of configurable symbols have been randomly selected, the feature game is triggered in which the triggering configurable symbols are replicated in a plurality of game windows (e.g. four). If the mystery configurable symbol is included in the trigger, one or more prize indicators are independently allocated to the mystery symbols in each of the game windows so that when the prizes are revealed, the game windows can have different prizes at the positions where the mystery symbols were previously located. In order for the gaming device to satisfy, meet, or maintain the designated or target RTP, target game outcome, target game payout, target game volatility, target win liability, target maximum win liability, and jurisdictional requirements, allocating the prize indicators to the game windows involves a series of different synchronous or asynchronous animations of revealing the prize indicator as well as generating the prize indicators based on one or more lookup tables detailed below.

For example, the implementations illustrated address the technical problem of satisfying volatilities to meet one or more target thresholds that may include a designated or target RTP, a target game outcome, a target game payout, a target game volatility, a target win liability, a target maximum win liability, and the like. Specifically, when a single window game instance is duplicated, multiplied or converted to multiple window game instances based on random outcomes, replicated and persistent configurable symbols increase the numbers of ways to win based on bet sizes. For example, when a single instance is multiplied into multiple windows with the same symbols, the chances of winning the multiplied games also proportionally increase, which may risk exceeding the max liability, unless parameters that may affect the RTP are technically controlled. As such, these configurations can also lead to higher than permitted return-to-player if not configured with proper controls. For example, this can lead to generating multiple game outcomes for each of the game instances in each of the multiple game instances, which can cause relatively higher latency and/or intensive data processing.

Implementations disclosed drive a game controller to generate game outcomes from a single window game instance converted to multi-window game instances with different parameters such as the number of game instances launched; the number of replicated configurable symbols that are persistent throughout the multi-window game instances; and the number of occurrences of such replicated configurable symbols that need to be counted during the game instances, and prize indicators determined individually from a set of possible prize indicators based on weightings for each configurable symbol. By way of example, in some implementations, a single window game instance is converted to multi-window game instances that are played (e.g., 4 windows (which can be less or more) each with separate game instances) after a triggering number of persistent configurable symbols is displayed in the single window game instance, where the triggering number of configurable symbols are then replicated in corresponding symbol positions in each of the multi-window game instances. By employing such a configuration, the technique can, among other things, satisfy or maintain game volatility and/or maximum win liability for such a multi-game round configuration while still maintaining and enhancing player engagement through an intuitive game presentation.

Additionally, conducting multiple simultaneous feature games, like a hold and spin game, may be computationally intensive, as it requires determining values for configurable symbols for reel strips that map to each symbol display position in each of the multiple simultaneous feature games. These processes may need hundreds of RNG determinations per spin cycle. In various embodiments, determination of the value of the configurable symbol may be suspended until after a reel stop position is determined for each reel and values for configurable symbols are only determined for those symbol display positions where a configurable symbol is determined to have landed or displayed. This increases the computational efficiency of the multiple simultaneous games. Further, since certain symbol positions already display configurable symbols, those symbol positions do not require any further determinations, thus further reducing the computational demand.

Further, visually transforming from a single window game instances to a variable number of multi-window game instances, sometimes animated, can create player confusion when converting from one or more game window game instances. The multi-window game instances still enable the player better appreciate the game instances by employing persistent configurable symbols being displayed across the multi-window game instances and, by doing so, such reliable placement of the configurable symbols simplifies otherwise complex game presentations for the player that avoids or reduces the need for understanding overly complicated calculations or repeated reference to game rules, and/or may improve player game understanding in multiple game windows and/or during multiple game rounds. The graphical user interface employing the illustrated implementations can improve the usability of electronic gaming devices.

Thus, implementations of the present disclosure are not merely new game rules or simply new display patterns. Rather, the implementations provide technologic improvements to gaming technology in the art of electronic gaming devices and software for such electronic gaming devices, and enhanced interactions between players and gaming devices or machines.

Moreover, the above example is not intended to be limiting, but merely exemplary of technologic improvements provided by some implementations of the present disclosure. Technological improvements of other implementations are readily apparent to those of ordinary skill in the art in light of the present disclosure.

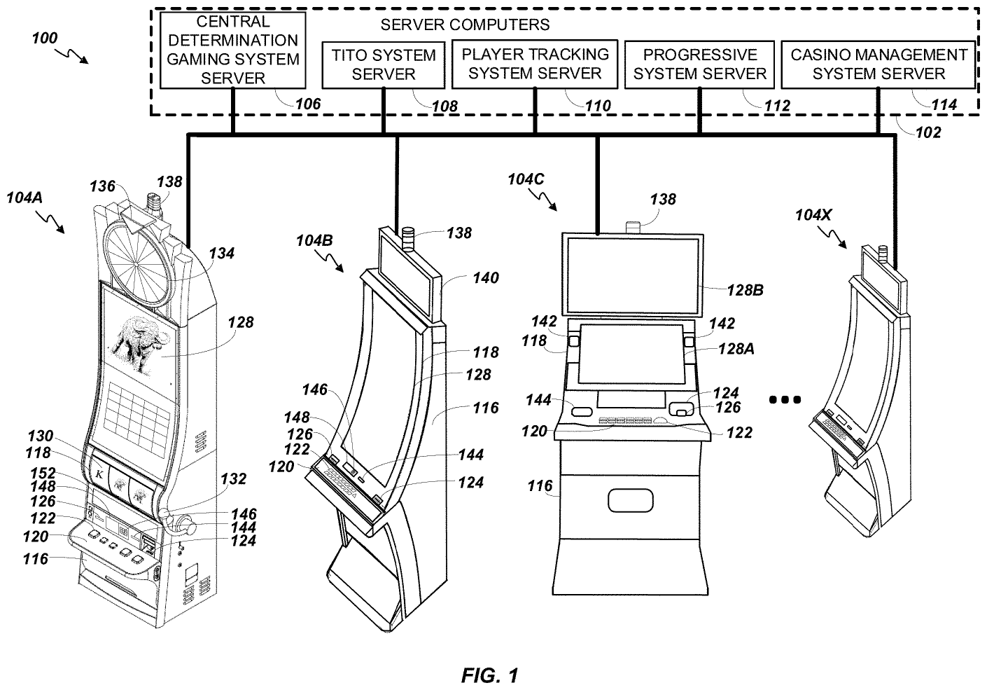

FIG. 1 illustrates several different models of EGMs which may be networked to various gaming related servers. The present invention can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a web site maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present invention may, in one or more embodiments, be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door 116 which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game. In embodiments where the reels are mechanical, mechanisms can be employed to implement greater functionality. For example, the boundaries of the gaming display area boundaries of the gaming display area 118 may be defined by one or more mechanical shutters controllable by a processor. The mechanical shutters may be controlled to open and close, to correspondingly reveal and conceal more or fewer symbol positions from the mechanical reels 130. For example, a top boundary of the gaming display area 118 may be raised by moving a corresponding mechanical shutter upwards to reveal an additional row of symbol positions on stopped mechanical reels. Further, a transparent or translucent display panel may be overlaid on the gaming display area 118 and controlled to override or supplement what is displayed on one or more of the mechanical reel(s).

In many configurations, the gaming machine 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. In some embodiments a ticket reader can be used which is only capable of reading tickets. In some embodiments, a different form of token can be used to store a cash value, such as a magnetic stripe card.

In some embodiments, a player tracking card reader 144, a transceiver for wireless communication with a player's smartphone, a keypad 146, and/or an illuminated display 148 for reading, receiving, entering, and/or displaying player tracking information is provided in EGM 104A. In such embodiments, a game controller within the gaming device 104A can communicate with the player tracking server system 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

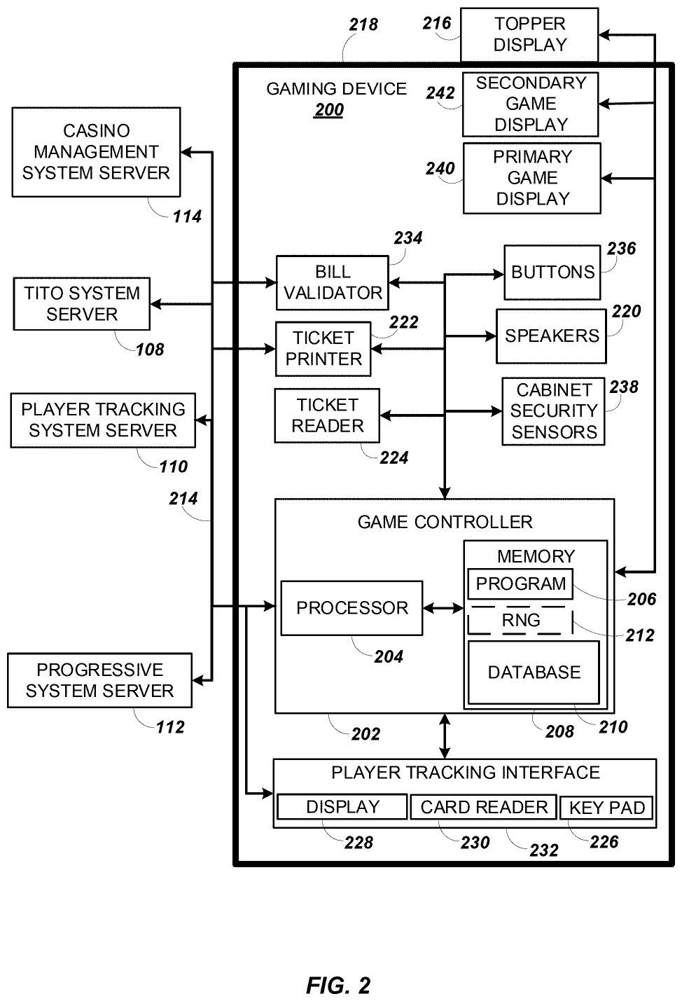

Many or all the above described components can be controlled by circuitry (e.g., a gaming controller) housed inside the main cabinet 116 of the gaming device 104A, the details of which are shown in FIG. 2.

Note that not all gaming devices suitable for implementing embodiments of the present invention necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door 118 which opens to provide access to the interior of the gaming device 104B. The main or service door 118 is typically used by service personnel to refill the ticket-out printer 126 and collect bills and tickets inserted into the bill validator 124. The door 118 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance. In some embodiments, the random number generator 212 is a pseudo-random number generator.

Alternatively, a game instance (i.e. a play or round of the game) may be generated on a remote gaming device such as a central determination gaming system server 106 (not shown in FIG. 2 but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a credit input mechanism such as a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The credit balance may be stored in a meter in memory 208 (or in a separate hardware meter). In some embodiment, memory 208 implements a credit meter to monitor to the credit balance and has a win meter that monitors any amounts won during any game instance(s) resulting from the wager. The balance of the win meter is transferred to the credit meter prior at the conclusion of the game instances. The player may also optionally insert a loyalty club card into the card reader 230. In some embodiments, the loyalty club card may also act as a credit input mechanism, by allowing a player to transfer funds from a centrally stored balance in order to establish a credit balance. During the game, the player views the game outcome on the game displays 240, 242. Other game and prize information may also be displayed.

When the player is done, he/she cashes out the credit balance (typically by pressing a cash out button to receive a ticket from the ticket printer 222). The ticket may be “cashed-in” for money or inserted into another machine to establish a credit balance for play.

FIG. 5 is a flow chart of an example embodiment of a method 500 of operating a gaming device. At step 505, the processor 204 initiates a first game instance (e.g. a base game) in response to receiving a wager (e.g. in response to a player making a wager selection using buttons as described above).

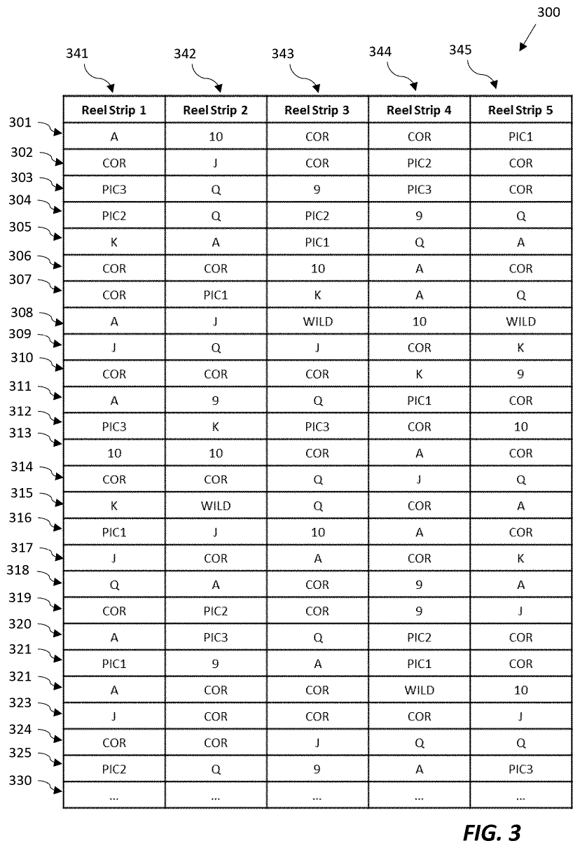

At step 510, the processor 204 configures the reel strips for a current game instance, in this respect, FIG. 3 illustrates an example of a set 300 of five reel strips 341, 342, 343, 344, 345. In the example, for illustrative purposes, twenty-five reel strip positions 301-325 are shown for each reel strip 341-345. Each reel strip position of each reel has a symbol. For example, a “Wild” symbol occupies the twenty-first reel strip position 321 of the fourth reel 344. The symbols shown on the reel strip are generally indicative of symbols that may be employed in the embodiments, however, other reels strips to those illustrated in FIG. 3 can be used, for example, reel strips where two or more wild symbols are placed at consecutive reel strip positions of a reel strip. Symbol position 330 indicates that the reel strips 341-345 may have more symbols than illustrated. For example, the reel strips 341-345 could have between 30 and 100 reel strip positions with the last reel strip position of a respective reel strip being treated as contiguous with the first reel strip position 301 as would be the case with a mechanical reel. The actual lengths of the game reel strips depend on factors such as the lengths of the stacks, the number of wild symbols (in general, the more wilds there are, the longer the reel strip needs to be to maintain the target RTP), and volatility (in general, the higher the prize value is, the longer the reel strip needs to be to lower the hit rate to maintain the target RTP). In some examples, the reel strips associated with different columns may be of different lengths to one another.

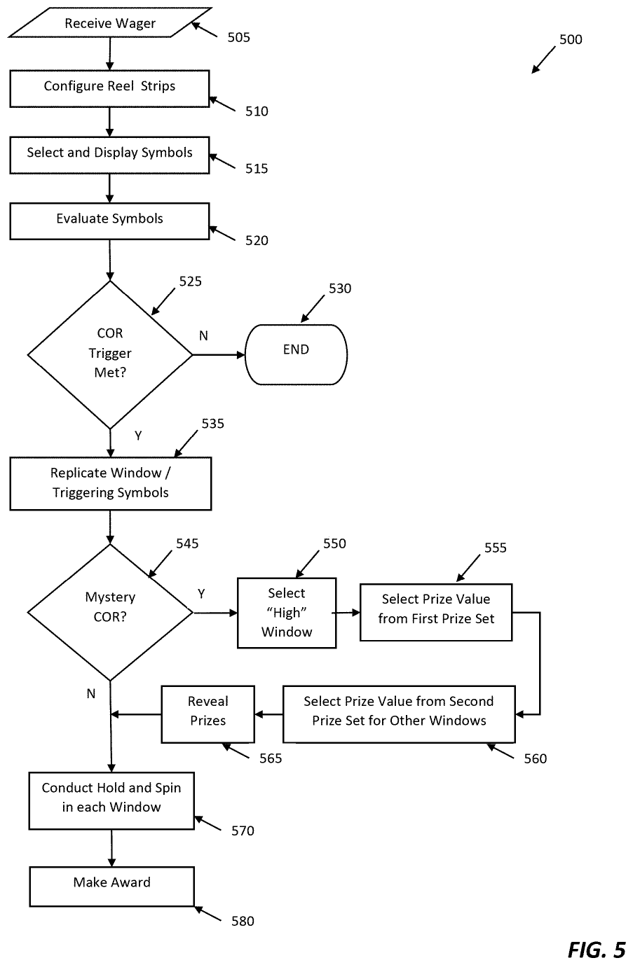

The reel strips 341-345 have configurable symbols (“COR” symbols), for example at the sixth reel strip position 306 of the first and second reel strips 341, 342. At step, 510 the processor 204 uses values returned from random number generator 211 to individually select prize indicators from a set of possible prize indicators based on weightings set out in a weight table as exemplified in Table 1 below. As exemplified by configurable symbols 731-736 in FIG. 6, the configurable symbols each have a common graphical component (in this example a money bag) and a differentiating component such as a credit value, prize name, or mystery icon, which are assigned dynamically to the configurable symbols.

TABLE 1

| Prize Indicator | Weighting |
|---|---|
| MAJOR JACKPOT | Weighting 1 |
| MINOR BONUS | Weighting 2 |
| MINI BONUS | Weighting 3 |
| MYSTERY ICON | Weighting 4 |
| 750 | Weighting 5 |
| 500 | Weighting 6 |
| 250 | Weighting 7 |
| 150 | Weighting 8 |
| 100 | Weighting 9 |
| 50 | Weighting 10 |

In an example embodiment, the weightings are preset based on the desired relative probability of the prize indicators. In an example, the prize value indicators are multiplier of the bet amount.

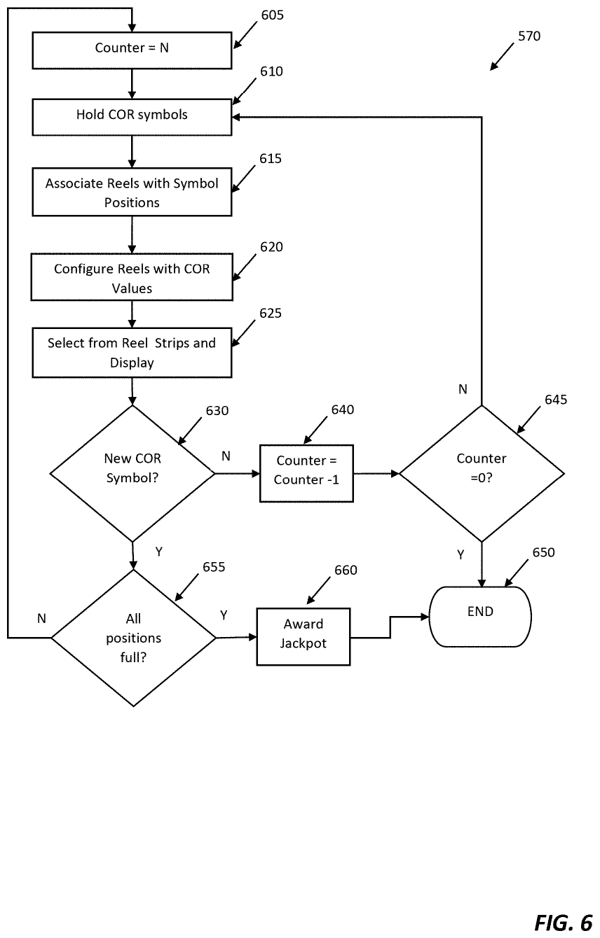

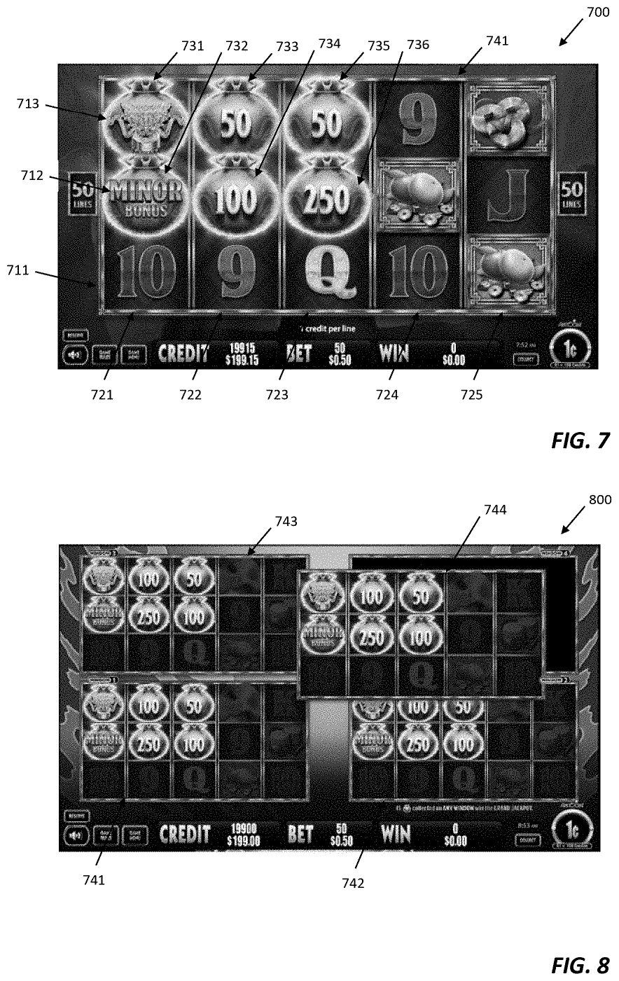

At step 515, the processor 204 selects symbols for a spinning reel game using the configured reel strips and controls the display 240 to display the selected symbols. FIG. 7 shows an example screen display 700 of a base game where symbols are selected from the five reel strips 341-345 for display in five columns of symbol positions 721-725 with three symbols being selected from each reel strip such that there are also three rows 711-713 of symbol positions.

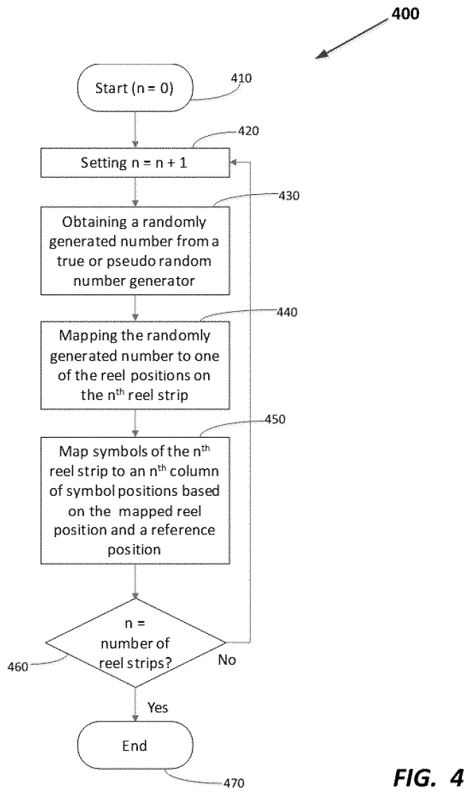

FIG. 4 is a flow chart of an example method 400 carried out by the processor 204 to select symbols from reel strips at step 510. At step 410, the processor 204 starts the process of selecting symbols with a counter (n) set at zero as symbols have not yet been selected from any reel strips. At step 420, the processor 204 increments the counter. In the first iteration, the counter is set to 1 to reflect that symbols are to be selected from a first reel strip. At step 430, the processor obtains a randomly generated number from a true or pseudo random number generator 212. At step 440 the processor maps the generated number to one of the reel positions of the nth reel strip. In the first iteration, this is the first reel strip. To map the generated number to one of the reel positions, the possible values that can be returned from the RNG 212 are divided into ranges and associated with specific ones of the reel positions in memory 208. In one example, these ranges are stored as a look-up table. In one example, the ranges are each the same size so that each of the reel strip positions has the same chance of been selected. In other examples, the ranges may be arranged to weight the relative chances of selecting specific reel strip positions.

At step 450, the processor 204 maps symbols of the nth reel strip to and nth column of symbol display positions based on the mapped reel position and a reference position. In an example, the reference position is the bottom position of the symbol positions of each column of symbol positions. In this example, the selected reel position (and hence the symbol at this position) is mapped to the bottom symbol position of the column. Referring to the example reel strips of FIG. 3, if the value returned by the RNG 212 is mapped to reel position 313 when three symbols are being selected from each reel, then for the first reel strip 341, “10” is mapped to a bottom symbol position, “PIC3” symbol 352 is mapped to a middle symbol position, and “A” symbol 351 is mapped to a top symbol position.

At step 460, the processor 460 determines whether symbols have been selected for all of the reel strips, and if not the processor 204 reverts to step 420 and iterates through steps 430, 440 and 450 until it is determined at step 460 that symbols have been selected from all n reel strips and mapped to all n columns of symbol positions after which the symbol selection process ends 470. Different numbers of symbols may be mapped to different numbers of symbol positions.

After the symbols of all reel strips have been mapped to symbol position, the processor 204 controls display 240 to display them at the symbol positions. An example of selected symbols for a first game instance is shown in the example screen display 700 of FIG. 7.

After the symbols are selected, at step 515, the processor 204 evaluates the selected symbols for one or more winning combinations based on a pay table stored in memory. In this example, processor 204 applies a “pay line” type evaluation by processing the selected symbols to identify instances of the same symbol appearing in defined pay lines comprising one symbol from of the columns 721-725 starting with (and including) the first column. Upon there being one or more winning combinations, the processor 204 makes an award, for example, by adding credit amounts defined by the pay table to a win meter or a credit meter in memory 204.

At step 525, the processor 204 determines whether to trigger further game play based on whether the selected symbols include at least a threshold number of configurable symbols and, if not, the game instance ends at step 530.

In this example, the threshold number of configurable symbols is six. According in an example, such as the screen display 700 shown in FIG. 7, where the processor 204 has selected six configurable symbols 731-736 in the first game window at step 515, at step 525 processor 204 will determine that the trigger condition is met.

At step 535, the processor 204 535 replicates the game window 741 and the triggering symbols to at least one other game window. FIG. 8 shows an example screen display 800 during this replication process.

In this example, the replication process involves the processor 204 controlling the display 240 to display a modified version of the first game window which is reduced in size in order to accommodate second to fourth game windows 742-744 and in which non-configurable symbols are greyed out to indicate that a fresh selection process will be conducted at this symbol position during the feature game. The replication process involves an animation of the first game window being copied to the other window positions. The screen display 800 captures the animation of the fourth game window 744 moving from a position at which the copy was generated (in an example, over the first window 741) to the top-right quadrant where it will be placed during the feature game. It will be observed that the process of the processor 204 replicating the game window result in the configurable symbols being displayed at corresponding symbol positions within the new windows.

At step 545, the processor 204 determines whether the selected symbols include one or more mystery configurable symbols and upon making a positive determination conducts a process 550-565 to select values for the mystery configurable symbols. In this example, the process involves, at step 550, the processor 204 randomly selecting one of the prizes to the “High” window, which will be a window for which a prize indicator assigned to the mystery COR is assigned from a first prize set which is has higher values by some measure than a second prize set used for the mystery prize configurable symbols in the other windows. Advantageously, this ensures that the game window in which the “high” prize will appear will vary.

In an example, the values of the first prize set are all higher than the second prize set. This example ensures that the not all the prize indicators allocated to mystery prize indicators will be the same. In another example, the values of the first prize set are higher on average than the values of the second prize set. In other examples, more than one prize value indicator may be selected from the first set. In an example, weighted tables in memory 204 define the prize sets and relative probabilities of prize indicators being selected.

As foreshadowed above, at step 555, the processor selects a prize value indicator from the first prize set for the selected high window using RNG 212 before selecting prize indicators for the other windows from the second prize set using the RNG 211 at step 560.

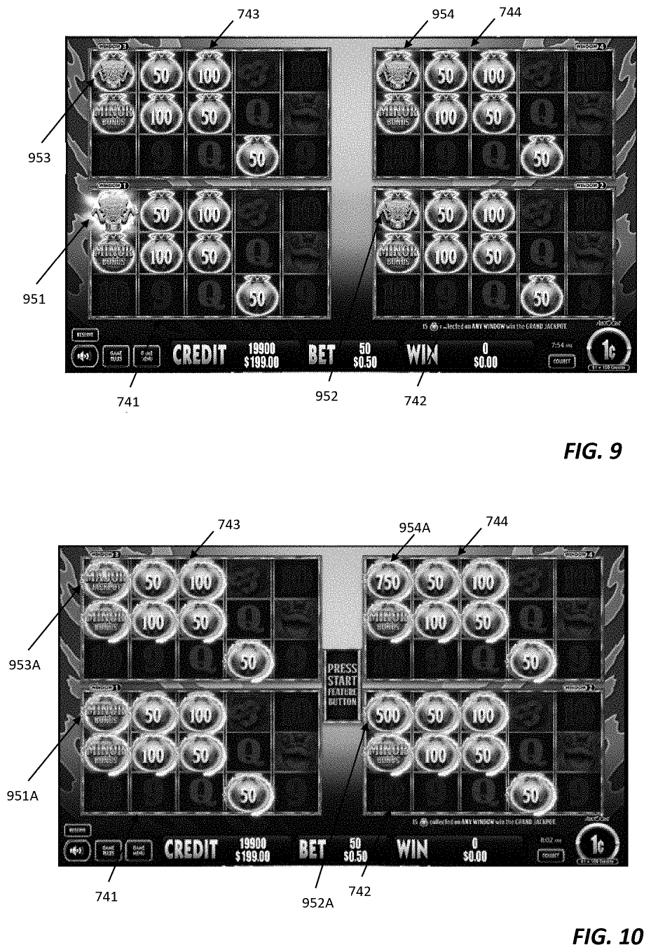

At step 565, processor 204 controls the display 240 to reveal the prizes. FIGS. 9 and 10 are example screen displays 900, 1000 of this reveal process 565.

Referring to FIG. 9, there is shown an example of four game windows 741-744 after the windows have been replicated at step 535. It will be observed that in this example, processor 204 selected seven configurable symbols at step 515 resulting in the trigger conditions being met at step 525 and seven configurable symbols being included in each game window after replication at step 535 including four configurable symbols with mystery prize indicators 951-954.

FIG. 9 is a screen display as the prize indicators assigned at steps 550-560 are about to be revealed at step 565. In FIG. 9, mystery prize indicator 951 is animated prior to a reveal of the assigned prize indicator at step 565. That is, each mystery indicator is animated in turn in order to reveal the assigned prize indicator.

FIG. 10 shows all of the revealed prize indicators 951A-954A. In this example, a “Minor Bonus” prize indicator 951A has been assigned to the mystery prize indicator 951 in the first game window 741; a 500 credit prize indicator 952A has been assigned to the mystery prize indicator 952 in the second game window 742; a “Major Jackpot” prize indicator 953A has been assigned to the mystery prize indicator 953 in the third game window 743; and a 750 credit prize indicator 954A has been assigned to the mystery prize indicator 954 in the fourth game window 744. Accordingly, an advantage of embodiments is that different prizes occur in different game windows based on the same triggering set of configurable symbols.

After the mystery prize values are revealed, the processor 204 independently conducts 570 a hold and spin game in each window 741-744. In other examples, the mystery prize values may be revealed at the conclusion of the hold and spin games.

FIG. 6 shows an example of a process implemented by processor 204 to conduct 570 hold and spin games in each game window. That is, in this example, the processor 204 independently conducts hold and spin games in each window. Methods of operating gaming devices to implement hold and spin and spin games incorporating configurable symbols are also described in Australian Patent Application No. 2015210489, filed 10 Aug. 2015 and entitled A SYSTEM AND METHOD FOR PROVIDING A FEATURE GAME, the disclosure of which is incorporated herein by reference.

At step 605, processor 204 sets an initial counter N for the hold and spin games, for example to three game instances. At step 610, the processor 204 hold the configurable symbols (COR symbols) in place including the configurable symbols from the base game instance or the replicated configurable symbol depending on the game window 741-744 on display 240 for which processor 204 is conducting the process.

At step 615, the processor 204 associates reel strips stored in memory with each individual symbol position that is not already occupied with a configurable symbol. In an example, reel strips used by processor 204 at step 615 comprise a mixture of configurable symbols and blank symbols. In another example, the reel strips include other symbols but they are greyed out. In an example, a first reel strip is used to control the relative probability of all the symbol positions being filled, which in this example, a Grand Jackpot being awarded. (A Grand Jackpot is typically the largest standalone prize awardable by the gaming device 200.) In an example, the processor 204 assigns the first reel strip to a symbol position first so that once only one symbol position remains the first reel strip will always be assigned to that symbol position. The first reel strip is typically longer than normal and has very few (or only one) configurable symbols. When less than one symbol position remains, processor 204 randomly selects a symbol position to associate the first reel strip with. Processor 204 continues to randomly select symbol positions and assigns reel strips from a separate, second set of reel strips having configurable symbols until all symbol positions not occupied by a held configurable symbol have an associated reel strip.

At step 620, the processor 204 assigns prize value indicators to the configurable symbols using a weighted table in a manner analogous to that described above. In this example, mystery prize indicators are not assigned at this stage but in other examples, mystery prize indicators may be among the prize values indicators that can be assigned at this step.

At step 625, the processor 204 selects from the assigned reel strips using a variant of the method described above in relation to FIG. 4. In this example, only a single position is selected from each reel strip which either will or will not have a configurable symbol. In an example, the processor 204 displays the selected symbols at the symbol positions in a random order.

At step 630, the processor 204 determines whether the selection has resulted in a new configurable symbol being selected and if it has, at step 655, the processor determines if all symbol positions are occupied with one or more configurable symbols. If processor 204 makes a negative determination (“N” path) at step 655, processor 204 reverts to step 605 and resets the counter to N (in this example 3) before iterating through steps 610 to 625 again. If processor 204 makes a positive determination (“Y” path) at step 655, a jackpot is awarded at step 660 and the hold and spin game ends for this window 650.

If at step 630, the processor 204 determines the selection has not resulted in a new configurable symbol being selected, at step 645, the processor 204 determines whether the counter has reached zero. In this way, if a new configurable symbol is not selected in N consecutive game instances (in this example three game instances), the hold and spin game ends for this game window at step 650.

After processor 204 ends the process for each window (that is, after the hold and spin games have been conducted 570 for each of the game windows), processor 204 makes and award of prizes shown by the prize indicators in each of the game window.

In an alternative example, the processor 204 may select the values to be revealed by mystery symbols at the same time as configuring the reel strips at step 510. For example, by assigning four values to each mystery symbol which will be revealed if the first game window is replicated. In another example, the processor 204 assigns a value to each mystery symbol in the base game instance, and if a mystery symbol is included in the triggering configurable symbols, this preassigned value is used in the first window 741 and values are assigned by processor 204 to the mystery symbols of the other game windows.

While in the above example, all three additional game windows 742-744 are immediately active, in other examples there may be requirements to activate the additional game windows. For example, defined numbers of configurable symbols being selected or displayed in order to successively unlock game windows.

Conducting multiple simultaneous hold and spin games may be computationally intensive, as it requires determining values for configurable symbols for reel strips that map to each symbol display position in each of the multiple simultaneous hold and spin games. These processes may need hundreds of RNG determinations per spin cycle. To increase the computational efficiency of the multiple simultaneous hold and spin games, in various embodiments, determination of the value of the configurable symbol may be suspended until after a reel stop position is determined for each reel and values for configurable symbols are only determined for those symbol display positions where a configurable symbol is determined to have landed or displayed. Further, since certain symbol positions already display configurable symbols, those symbol positions do not require any further determinations, thus further reducing the computational demand. In certain embodiments, reels may begin spinning after reel stop positions are determined, and stop after the values associated with configurable symbols that are to be displayed have been determined.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. An electronic gaming device comprising:
a display device operable to display at least a portion of a plurality of reels, each reel having a plurality of symbol positions;
a controller comprising a processor and memory storing a symbol set including a plurality of symbols, and instructions, which, when executed, cause the processor to at least:
conduct a base game by:
configuring a set of reel strips for the base game by mapping for each configurable symbol of the set of reel strips, an indicator to form part of the respective configurable symbol upon the configurable symbol being displayed, wherein each indicator is selected from a plurality of prize value indicators and a mystery prize indicator based on one or more random numbers generated by a random number generator;
mapping, based on one or more random numbers generated by a random number generator, symbols from the set of reels strips for a plurality of symbol positions of a first game window;
controlling the display device to display a set of game symbols, selected from the set of reels strips using the random number generator, at the plurality of symbol positions in the first game window;
trigger a feature game upon the set of game symbols including a threshold number of triggering configurable symbols;
conduct the feature game by:
controlling the display to display a plurality of game windows including the first game window;
replicating the triggering configurable symbols of the first game window at corresponding symbol positions in each other game window displayed;
upon the triggering configurable symbols including one or more configurable symbols with a mystery indicator, revealing prize value indicators determined individually from a set of possible prize indicators based on weightings for each configurable symbol with a mystery indicator and each replicated configurable symbol with a mystery indicator;
conducting, until an end condition is met, game instances in which further configurable symbols may be selected at one or more symbol positions not already occupied by a configurable symbol; and
accessing the memory to determine whether to make an award of at least one or more prizes indicated by the prize value indicators in each active game window of the plurality of game windows.

2. The electronic gaming device as claimed in claim 1, wherein the instructions, when executed, cause the processor to determine prize value indicators using the random number generator for each replica of a configurable symbol, and wherein the prize value indicators of at least two corresponding symbol positions are different.

3. The electronic gaming device as claimed in claim 2, wherein the instructions, when executed, cause the processor to select at least a first prize value indicator from a first set of prize value indicators and at least a second prize value indicator from a second set of prize value indicators different from the first prize value indicator.

4. The electronic gaming device as claimed in claim 3, wherein the first set of prize value indicators has larger prize value indicators than the second set of prize value indicators.

5. The electronic gaming device of claim 1, wherein the instructions, when executed, cause the processor to determine prize value indicators for each configurable symbol having a mystery indicator subsequent to the feature game being triggered.

6. The electronic gaming device of claim 1, wherein the instructions, when executed, cause the processor to determine prize value indicators for each replicated configurable symbol having a mystery indicator subsequent to the feature game being triggered.

7. The electronic gaming device of claim 5, wherein there are four game windows.

8. The electronic gaming device of claim 1, wherein all of the game windows are active.

9. The electronic gaming device of claim 1, wherein initially the first game window of the plurality of game windows are active, and when the instructions are executed by the processor they cause the processor to activate one or more additional game windows in response to one or more activation conditions being met.

10. The electronic gaming device of claim 1, wherein conducting game instances until an end condition is met in which further configurable symbols may be selected at one or more symbol positions not already occupied by a configurable symbol comprises the processor, conducting game instances for each game window until an end condition is met in respect of the game window by:
retaining configurable symbols from each prior game instance, and
performing, in each game instance, a selection for each symbol position at which a configurable symbol is not retained from reel strips comprising configured configurable symbols using the random number generator.

11. A non-transitory computer-readable medium comprising a display operable to display a portion of a plurality of reels, a random number generator, instructions for conducting a game on a plurality of devices, and a controller comprising a processor, and the instructions, when executed, cause the processor to perform the steps of:
in a base game:
configuring a set of reel strips for the base game by mapping for each configurable symbol of the set of reel strips, an indicator to form part of the respective configurable symbol upon the configurable symbol being displayed, wherein each indicator is selected from a plurality of prize value indicators and a mystery prize indicator based on one or more random numbers generated by a random number generator,
iterating a selection of a set of game symbols, based on one or more random numbers generated by a random number generator, from the set of reels strips for a plurality of symbol positions of a first game window, and
controlling the display to display the set of game symbols at the plurality of symbol positions in the first game window;
triggering a feature game upon the set of game symbols including a threshold number of triggering configurable symbols; and
in the feature game:
controlling the display to display a plurality of game windows including the first game window;
replicating the triggering configurable symbols of the first game window at corresponding symbol positions in each other game window;
upon the triggering configurable symbols replicated including one or more configurable symbols with a mystery indicator, controlling the display to animate the mystery indicator to reveal prize value indicators determined indicators determined individually from a set of possible prize indicators based on weightings for each configurable symbol with a mystery indicator and each replicated configurable symbol with a mystery indicator;
conducting, until an end condition is met, game instances in which further configurable symbols may be selected at one or more symbol positions not already occupied by a configurable symbol; and
generating an outcome that awards at least a prize indicated by the prize value indicators in each active game window of the plurality of game windows.

12. The non-transitory computer-readable medium of claim 11, wherein initially the first game window of the plurality of game windows are active, the instructions, when executed, cause the processor to perform the step of activating one or more additional game windows in response to one or more activation conditions being met.

13. The non-transitory computer-readable medium of claim 11, wherein instructions, when executed, cause the processor to perform the step of determining prize value indicators using the random number generator for each replica of a configurable symbol and wherein the prize value indicators of at least two corresponding symbol positions are different.

14. The non-transitory computer-readable medium of claim 11, wherein instructions, when executed, cause the processor to perform the step of selecting at least a first prize value indicator from a first set of prize value indicators and at least a second prize value indicator from a second, different set of prize value indicator.

15. The non-transitory computer-readable medium of claim 14, wherein the first set of prize value indicators has larger prize value indicators than the second set of prize value indicators.

16. An electronic gaming system comprising:
at least one display device;
a random number generator operable to generate one or more random numbers;
one or more processors; and
at least one memory storing instructions which, when executed by the one or more processors, cause the one or more processors to:
conduct a first game instance by:
mapping on each configurable symbol of a set of reel strips, based on a reel position and reference position, an indicator to form part of the respective configurable symbol upon the configurable symbol being displayed, wherein each indicator is selected from a plurality of prize value indicators and a mystery prize indicator using the random number generator;
controlling the display device to display a set of game symbols, selected from the set of reels strips using the random number generator, at a plurality of symbol positions in a first game window;
initiating a second game instance based upon the set of game symbols including a threshold number of triggering configurable symbols; and
conduct a second game instance by:
controlling the display to display a plurality of game windows including the first game window;
replicating the triggering configurable symbols of the first game window at corresponding symbol positions in each other game window;
upon the replicated triggering configurable symbols including one or more configurable symbols with a mystery indicator, revealing prize value indicators determined indicators determined individually from a set of possible prize indicators based on weightings for each configurable symbol with a mystery indicator and each replicated configurable symbol with a mystery indicator;
conducting, until an end condition is met, game instances in which further configurable symbols may be selected at one or more symbol positions not already occupied by a configurable symbol; and
accessing the memory to determine whether an award of at least one or more prizes indicated by the prize value indicators in each active game window of the plurality of game windows.

17. The electronic gaming system of claim 16, wherein instructions, when executed, cause the one or more processors to determine prize value indicators for each configurable symbol having a mystery indicator subsequent to the second game instance being triggered.

18. The electronic gaming system of claim 16, wherein instructions, when executed, cause the one or more processors to determine prize value indicators for each replicated configurable symbol having a mystery indicator subsequent to the second game instance being triggered.

19. The electronic gaming system of claim 16, wherein there are four game windows and wherein all of the game windows are active.

20. The electronic gaming system of claim 16, wherein conducting game instances until an end condition is met in which further configurable symbols may be selected at one or more symbol positions not already occupied by a configurable symbol comprises conducting game instances for each game window until an end condition is met in respect of the game window by:
retaining configurable symbols from each prior game instance, and
performing, in each game instance, a selection for each symbol position at which a configurable symbol is not retained from the set of reel strips comprising configured configurable symbols using the random number generator.
